(19) United States
(12) Patent Application Publication
(10) Pub. No.: US 2013/0182881 A1
(43) Pub. Date: Jul. 18, 2013

(54) EARPHONE CONNECTOR

(71) Applicants: Atsuhito Horino, Ebina (JP); Shinsuke Kunishi, Hadano-shi (JP)

(72) Inventors: Atsuhito Horino, Ebina (JP); Shinsuke Kunishi, Hadano-shi (JP)

(73) Assignee: MOLEX INCORPORATED, Lisle, IL (US)

(21) Appl. No.: 13/554,473

(22) Filed: Jul. 20, 2012

(30) Foreign Application Priority Data
Jul. 20, 2011 (JP) 2011-158760

(51) Int. Cl. H04R 1/10

(52) U.S. Cl. CPC H04R 1/1066
USPC 381/380

(57) ABSTRACT

An earphone connector having a plug provided with a cylindrical inserted portion and a locking claw that protrudes from the side surface of the inserted portion, and a receptacle provided with a fitting indentation that encloses at least the front-end portion of the inserted portion and an insertion opening formed in a fitting surface that communicates with the fitting indentation. The insertion opening includes a cylindrical portion through which the inserted portion passes and an indentation through which the locking claw passes. A spring member in contact with the locking claw is disposed within the fitting indentation, so that when the inserted portion is inserted into the insertion opening, the locking claw passes through the indentation and is enclosed within the interior of the fitting indentation and the inserted portion is rotated. The spring force of the spring member causes a moment that further rotates the inserted portion to act on the locking claw.

### REFERENCE To RELATED APPLICATIONS

The Present Disclosure claims priority to prior-filed Japanese Patent Application No. 2011-158760, entitled “Earphone Connector,” filed on 20 Jul. 2011 with the Japanese Patent Office. The content of the aforementioned Patent Application is incorporated in its entirety herein.

### BACKGROUND OF THE PRESENT DISCLOSURE

The Present Disclosure relates, generally, to an earphone connector, and, more particularly, to an earphone connector which prevents rotation of the inserted portion in the opposite direction so that while the cable is still removable, the plug will not come out of the receptacle, thereby preventing unwanted disconnection of the cable.

Conventional earphones placed on the auricle include the so-called earphone-type headphone that is inserted into the external ear canal and that has no protruding parts. An example is disclosed in Japanese Patent Application No. 2009-068004, the content of which is incorporated herein in its entirety.

FIG. 13 illustrates the connective structure between a conventional earphone and cable. In FIG. 13, 811 is the housing of an earphone, and in the interior of the housing 811 is mounted a driver unit (not shown) provided with vibrating plates and the like. Moreover, a mesh-like protective plate 848 provided with a relatively large number of apertures is disposed at the front surface of the earphone; that is, in front of the vibrating plates. In addition, 813 is the rear housing of the earphone wherein a duct-shaped cable holder 815 is extended therein, and contained within the cable holder 815 is an electric cable 891 with one end connected to the driver unit and the other end connected to a piece of audio equipment (not shown). When an earphone is placed in a concave portion of the auricle, the protective plate 848 disposed at the front surface of the earphone faces the entrance of the outer ear canal, and the sound generated by the vibration of the vibrating plates passes through the apertures of the protective plate 848, becoming incident upon the interior of the outer ear canal, reaching the eardrum.

However, in the aforementioned earphone, the earphone and electric cable 891 are connected as a single unit, so if a break in the electric cable 891 or other trouble should occur, it becomes necessary to replace the earphone together with the electric cable 891, thus increasing the replacement cost. Originally, earphones connected using an inserted-type jack on the electric cable 891 so that the electric cable 891 is removable were also proposed. However, the holding power of an inserted-type jack is small, so if the electric cable 891 is pulled during use, it was easily disconnected. To solve this problem, it was also proposed to have the jack be rotated after insertion so that a protrusion provided on the jack becomes engaged, but the jack rotates easily so if the electric cable 891 is pulled, it is again similarly easily disconnected.

### SUMMARY OF THE PRESENT DISCLOSURE

The Present Disclosure has as an object to solve the aforementioned conventional problems and provide a highly reliable earphone connector whereby, when the inserted portion of the plug is inserted into the insertion opening of the receptacle and then rotated, a spring member disposed in the receptacle generates moment that further rotates the inserted portion, thus preventing rotation of the inserted portion in the opposite direction so that while the cable is still removable, the plug will not come out of the receptacle, thereby preventing unwanted disconnection of the cable.

To this end, the earphone connector according to the Present Disclosure is an earphone connector wherein a cable is electrically connected to a driver unit that generates sound and is provided with an earphone. The earphone has a plug provided with a cylindrical inserted portion and a locking claw that protrudes from the side surface of the inserted portion, and a receptacle provided with a fitting indentation that encloses at least the front-end portion of the inserted portion and an insertion opening formed in a fitting surface that communicates with the fitting indentation. The insertion opening includes a cylindrical portion through which the inserted portion passes, an indentation through which the locking claw passes, and a spring member in contact with the locking claw is disposed within the fitting indentation, so that when the inserted portion is inserted into the insertion opening, the locking claw passes through the indentation and is enclosed within the interior of the fitting indentation and the inserted portion is rotated. The spring force of the spring member causes a moment that further rotates the inserted portion to act on the locking claw.

In another aspect of the earphone connector of the Present Disclosure, the locking claw protrudes from the inserted portion in a direction radial to the inserted portion, and the spring member being deformed upon being put in contact with the tip of the locking claw generates a spring force in the direction toward the central axis of the inserted portion. When the inserted portion is rotated and the direction in which the locking claw protrudes is inclined with respect to the direction of the spring force, the moment acts upon the locking claw.

In a further aspect of the earphone connector of the Present Disclosure, the insertion opening includes a detent portion formed adjacent to the indentation. When the inserted portion is inserted into the insertion opening, the locking claw passes through the indentation and is enclosed within the fitting indentation and then the inserted portion is rotated. The detent portion engages the locking claw, thereby preventing the inserted portion from coming out from the insertion opening.

In another further aspect of the earphone connector of the Present Disclosure, the fitting indentation includes a stopper that stops the rotation of the inserted portion at a stipulated angle of rotation. In another further aspect of the earphone connector of the Present Disclosure, the locking claw may be a single claw or a plurality thereof. In another further aspect of the earphone connector of the Present Disclosure, the locking claw is a plug terminal and the spring member is a receptacle terminal, and thus electrical continuity is achieved through the contact of the locking claw and spring member.

In another further aspect of the earphone connector of the Present Disclosure, the plug is further provided with an auxiliary locking claw that protrudes from the side surface of the inserted portion, and the insertion opening is further provided with an auxiliary indentation through which the auxiliary locking claw passes and an auxiliary detent portion formed adjacent to the auxiliary indentation. When the inserted portion is inserted into the insertion opening, the auxiliary locking claw passes through the auxiliary indentation and is enclosed within the fitting indentation and then the inserted portion is rotated, the auxiliary detent portion engages the auxiliary locking claw, thus preventing the inserted portion from coming out of the insertion opening.

With the Present Disclosure, when the inserted portion of the plug is inserted into the insertion opening of the receptacle and then rotated, the spring member disposed in the receptacle generates moment that further rotates the inserted portion. This prevents rotation of the inserted portion in the opposite direction so that while the cable is still removable, the plug will not come out of the receptacle, thereby preventing unwanted disconnection of the cable and thus reliability can be improved.

### BRIEF DESCRIPTION OF THE FIGURES

The organization and manner of the structure and operation of the Present Disclosure, together with further objects and advantages thereof, may best be understood by reference to the following Detailed Description, taken in connection with the accompanying Figures, wherein like reference numerals identify like elements, and in which:

FIG. 1 is a cross section of an earphone connector according to one embodiment of the Present Disclosure, being a cross section at Arrows A-A of FIG. 2(c);

FIG. 2 is a five-view orthographic projection of the earphone connector of FIG. 1, where (a) is a top view, (b) is a left-side view, (c) is a rear view, (d) is a right-side view, and (e) is a front view;

FIG. 3 is a perspective view of the earphone connector of FIG. 1, where (a) is a perspective view illustrating the state with the plug inserted into the receptacle, (b) is a first perspective view showing the state before the plug is inserted into the receptacle, and (c) is a second perspective view showing the state before the plug is inserted into the receptacle;

FIG. 4 is a two-view orthographic projection of the pre-engagement state of the earphone connector of FIG. 1, where (a) is a side view and (b) is a bottom view;

FIG. 5 is a drawing used to explain the operation of the earphone connector of FIG. 1, where (a) is a side view illustrating the state in which the plug is inserted into the receptacle, (b-1) is a bottom view illustrating the state in which the plug is inserted into the receptacle, (b-2) is view (b-1) with the housing portion of the receptacle omitted, (c-1) is a rear view illustrating the state in which the plug is inserted into the receptacle, (c 2) is view (c-1) with the housing portion of the receptacle omitted, (d-1) is a rear view of the plug inserted into the receptacle and rotated, and (d-2) is view (d-1) with the housing portion of the receptacle omitted;

FIG. 6 is a drawing used to explain the operation of the earphone connector of FIG. 1, where (a) is a cross section at Arrows B-B of FIG. 5(c-1), and (b) is a cross section at Arrows C-C of FIG. 5(d-1);

FIG. 7 is a perspective view of an earphone connector according to one embodiment of the Present Disclosure, where (a) is a perspective view illustrating the state with the plug inserted into the receptacle, (b) is a first perspective view showing the state before the plug is inserted into the receptacle, and (c) is a second perspective view showing the state before the plug is inserted into the receptacle;

FIG. 8 is a two-view orthographic projection of the pre-engagement state of the earphone connector of FIG. 7, where (a) is a side view, and (b) is a bottom view;

FIG. 9 is a drawing used to explain the operation of the earphone connector of FIG. 7, where (a) is a side view illustrating the state in which the plug is inserted into the receptacle, (b) is a bottom view illustrating the state in which the plug is inserted into the receptacle, (c) is a rear view illustrating the state in which the plug is inserted into the receptacle, (d) is a side view of the plug inserted into the receptacle and rotated, and (e) is a rear view of the plug inserted into the receptacle and rotated;

FIG. 10 is a perspective view of an earphone connector according to one embodiment of the Present Disclosure, where (a) is a perspective view illustrating the state with the plug inserted into the receptacle, (b) is a first perspective view showing the state before the plug is inserted into the receptacle, and (c) is a second perspective view showing the state before the plug is inserted into the receptacle;

FIG. 11 is a two-view orthographic projection of the pre-engagement state of the earphone connector of FIG. 10, where (a) is a side view and (b) is a bottom view;

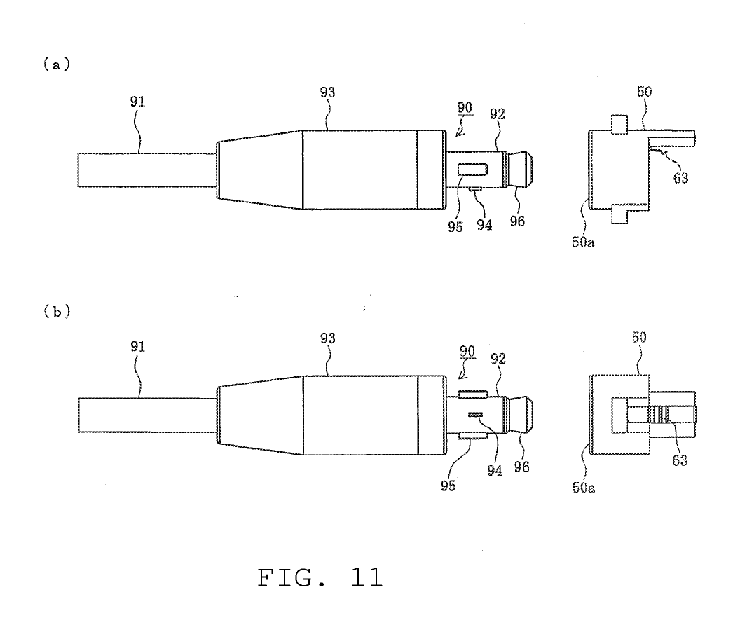

FIG. 12 is a drawing used to explain the operation of the earphone connector of FIG. 10, where (a) is a side view illustrating the state in which the plug is inserted into the receptacle, (b) is a bottom view illustrating the state in which the plug is inserted into the receptacle, (c) is a rear view illustrating the state in which the plug is inserted into the receptacle, (d) is a side view of the plug inserted into the receptacle and rotated, and (e) is a rear view of the plug inserted into the receptacle and rotated; and

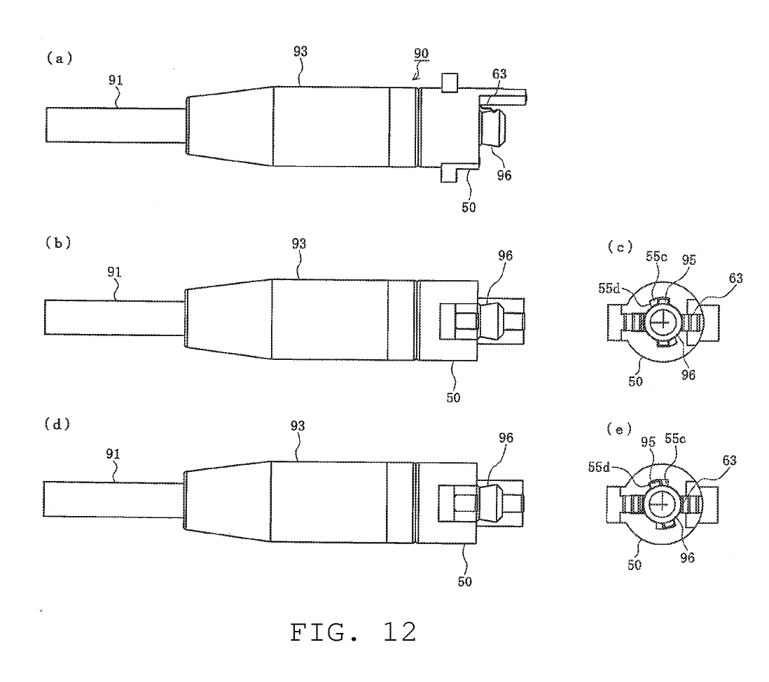

FIG. 13 is a drawing illustrating the connective structure between a conventional earphone and cable.

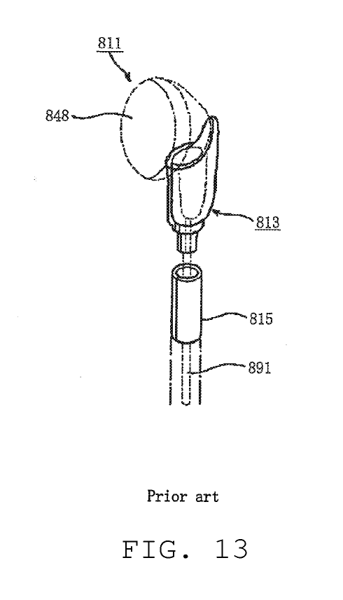

### DESCRIPTION OF THE PREFERRED EMBODIMENTS

While the Present Disclosure may be susceptible to embodiment in different forms, there is shown in the Figures, and will be described herein in detail, specific embodiments, with the understanding that the Present Disclosure is to be considered an exemplification of the principles of the Present Disclosure, and is not intended to limit the Present Disclosure to that as illustrated.

As such, references to a feature or aspect are intended to describe a feature or aspect of an example of the Present Disclosure, not to imply that every embodiment thereof must have the described feature or aspect. Furthermore, it should be noted that the description illustrates a number of features. While certain features have been combined together to illustrate potential system designs, those features may also be used in other combinations not expressly disclosed. Thus, the depicted combinations are not intended to be limiting, unless otherwise noted.

In the embodiments illustrated in the Figures, representations of directions such as up, down, left, right, front and rear, used for explaining the structure and movement of the various elements of the Present Disclosure, are not absolute, but relative. These representations are appropriate when the elements are in the position shown in the Figures. If the description of the position of the elements changes, however, these representations are to be changed accordingly.

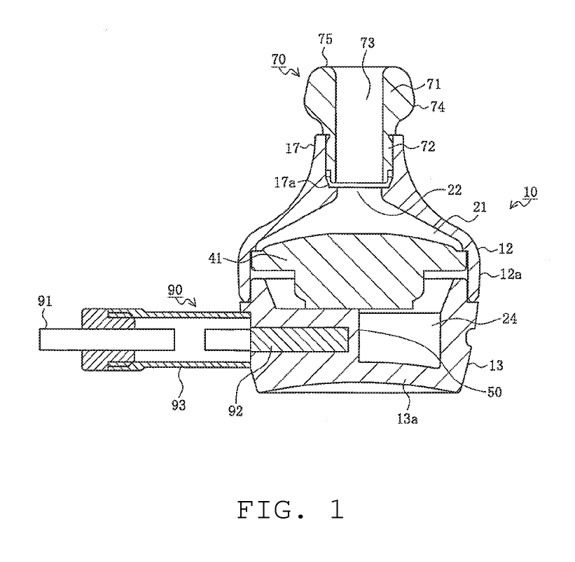

Referring to FIGS. 1-2, 10 is an earphone according to one embodiment, which is used by being placed on the auricle of the user, and which is a miniature audio speaker that reproduces sound when driven by audio signals which are electrical signals. Moreover, the earphone 10 has a case 11 acting as a housing that houses a driver unit 41 as the speaker unit, and also has an earpiece 70 that, in a first usage example, is mounted to the case 11 and at least its front-end portion 75 is an external ear canal insertion member that can be inserted into the external ear canal of the user.

The case 11 is provided with a front case 12 positioned at its front surface and a truncated cone-shaped rear case 13 joined to the rear side of the base 12a of the front case 12. Moreover, as shown in FIG. 1, the driver unit 41 is held within the case 11 in the state of being sandwiched between the front case 12 and rear case 13 front and rear (or up and down in FIG. 1). Note that the driver unit 41 is of the so-called dynamic type, generating sound by the vibration of vibrating plates (not shown).

Moreover, the rear-surface portion 13a that closes off the rear surface of the rear case 13 is a substantially plate-shaped member which forms a rear space 24 to the rear of the driver unit 41 (or below it in FIG. 1) within the case 11 that is overall cylindrically-shaped, or more specifically the space has a shape that combines a truncated cone and a cylinder. Note that the case 11 is made of hard plastic with a relatively large specific gravity.

The front case 12 includes, in addition to the cylindrical base 12a, a truncated cone-shaped conical portion 16 that protrudes forward from the base 12a, and a cylindrical inserted portion mount 17 that protrudes from the front end of the conical portion 16. The conical portion 16 is formed such that the diameter of its front end is smaller than its base end (the portion connected to the base 12a), and thus a front space 21 is formed as a truncated cone-shaped space in front (or above in FIG. 1) of the driver unit 41 within the case 11. In addition, on the inserted portion mount 17 is formed a case sound-guide hole 22 as a sound-guide hole which is a cylindrical opening whose front end communicates with the front space 21 and whose rear end is open. Thereby, sound generated by the driver unit 41 passes through the front space 21 and case sound-guide hole 22 and is incident upon the outer ear canal of the user. Note that the conical portion 16 is formed such that the centerline of its front end is coincident with the centerline of its base end.

Moreover, the earpiece 70 is an integrally-formed member, provided with a cylindrical main body 71 and a thick-walled swelling portion 74 where the outside surface becomes wider diagonally going from the front end toward the rear end of the main body 71. Note that the portion extending rearward from the swelling portion 74 of the main body 71 becomes the mounting portion 72. This mounting portion 72 is inserted into an enclosing indentation 71a formed on the inside surface of the inserted portion mount 17 of the case 11; that is, the inside surface of the case sound-guide hole 22.

In the center of the main body 71 is formed a piece sound-guide hole 73, a cylindrical opening having its front and rear ends open. In the state where the earpiece 70 is mounted to the inserted portion mount 17, the piece sound-guide hole 73 communicates with the case sound-guide hole 22. Note that the inside diameter of the piece sound-guide hole 73 is preferably the same as the inside diameter of the case sound-guide hole 22.

The swelling portion 74 has an external shape like a truncated cone, having its smallest outside diameter at the front-end portion 75, where the outside diameter becomes greater the further down one goes. To wit, the outside surface of the swelling portion 74 is tapered with a narrow tip, so it can be easily inserted into the outside ear canal. Note that it is preferable for the maximum outside diameter of the swelling portion 74 to be greater than the outside diameter of the upper end of the inserted portion mount 17 of the case 11.

Moreover, when the swelling portion 74 of the earpiece 70 is inserted into the outer ear canal, the inside surface of the outer ear canal is pressed upon and deforms so that at least one portion of the inside surface of the outer ear canal is in tight contact with the outside surface of the swelling portion 74. Thus, since the outside surface of the swelling portion 74 is tapered with a narrow tip, when the swelling portion 74 is inserted into the outer ear canal, the inside surface of the outer ear canal can be smoothly deformed and the tightness of adherence of the outside surface of the swelling portion 74 to the inside surface of the outer ear canal is high without damaging the outer ear canal. Further, the fit and feel of the earpiece are good.

Moreover, a receptacle 50 is disposed upon the rear case 13 as a female connector that functions as one side of the earphone connector. Specifically, the housing portion of this receptacle 50 is formed integrally with the rear case 13. Furthermore, the receptacle 50 is electrically connected to the driver unit 41. In addition, a plug 90 as a male connector that functions as the other side of the earphone connector fits into the receptacle 50. Specifically, an inserted portion 92 at the front end of this plug 90 is inserted into the receptacle 50.

Moreover, an electrical cable 91 as the cable in electrical continuity with the driver unit 41 is terminated at the plug 90. To wit, an end of the electrical cable 91 is connected. In the illustrated example, the electrical cable 91 extends from the rear end of a cable holder 93 in the plug 90. Note that for convenience in drafting, only the portions of the electrical cable 91 near the cable holder 93 are drawn; the other portions are omitted. Moreover, the other end of the electrical cable 91 (not shown) is connected to a piece of audio equipment (not shown).

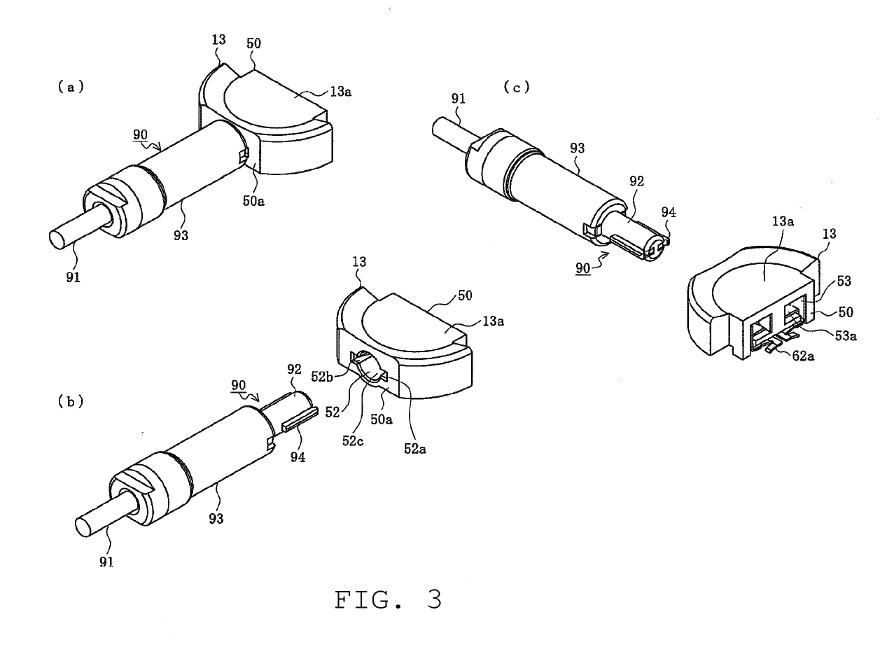

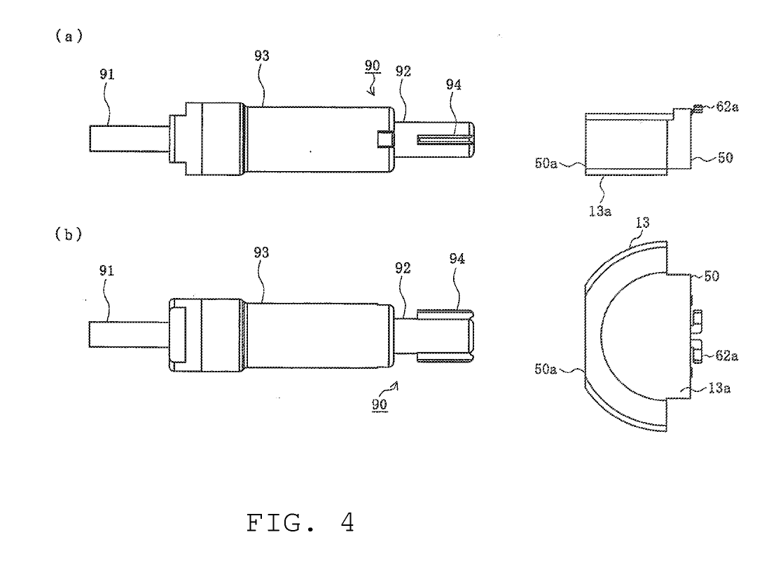

For a description of the constitution and operation of the aforementioned earphone connector, reference is made to FIGS. 3-6. As illustrated, the plug 90 is provided with a cylindrical inserted portion 92 that extends forward from the front end of a tubular cable holder 93, and a pair of engaging protrusions 94 that function as locking claws disposed on the side surface of this inserted portion 92. The engaging protrusions 94 are fin-shaped protruding members extending in the axial direction and disposed in positions facing each other on the cylindrical peripheral surface of the cable holder 93, which protrude in the radial direction of the inserted portion 92 from the side surface of this inserted portion 92. Moreover, the engaging protrusions 94, or at least their tips, or even the surfaces of their ridges, are made of electrically conductive material and are each connected to electrically conductive conductors (not shown) contained within the electrical cable 91. In other words, the pair of engaging protrusions 94 are members that function not only as locking claws but also function as the terminals of the plug 90 as the male connector, or namely as plug terminals, and are disposed at 180° symmetry with respect to the centerline of the inserted portion 92.

Note that as described above, the receptacle 50 is a member that is formed integrally with the rear case 13 of the earphone 10, but in FIGS. 3-6, for ease of explanation, the portions of the receptacle 50 other than on the rear case 13 and earphone 10 are omitted.

Inside the aforementioned receptacle 50 is formed a hollow fitting indentation 53 that encloses at least the front-end portion of the inserted portion 92, and as shown in FIG. 3(c), the rear end of this fitting indentation 53 is open to the rear end of the receptacle 50. In addition, as shown in FIG. 3(b), a flat surface facing the plug 90, or namely a fitting surface 50a, is formed on the front end of the receptacle 50, and on this fitting surface 50a is formed an insertion opening 52 into which the inserted portion 92 of plug 90 is inserted. Note that this insertion opening 52 communicates with the fitting indentation 53 in the interior of the receptacle 50.

The insertion opening 52 includes a cylindrical portion 52c having a circular cross section, and a pair of engaging indentations 52a indented below the side surface of the cylindrical portion 52c. These engaging indentations 52a are the portions into which the engaging protrusions 94 of plug 90 enter and are disposed at 180° symmetry about the centerline of the cylindrical portion 52c. In addition, above and below adjacent portions of the engaging indentations 52a are insertion opening wall members 52b that extend in the forward and backward directions of the receptacle 50, engaging the rear end of the engaging protrusions 94 and functioning as detents that prevent the plug 90 from coming out. Note that the fitting indentation 53 is provided with a substantially rectangular cross section and extends in the forward and backward directions of the receptacle 50, and is also provided with a pair of first sidewalls 53a and a pair of second sidewalls 53b that face each other.

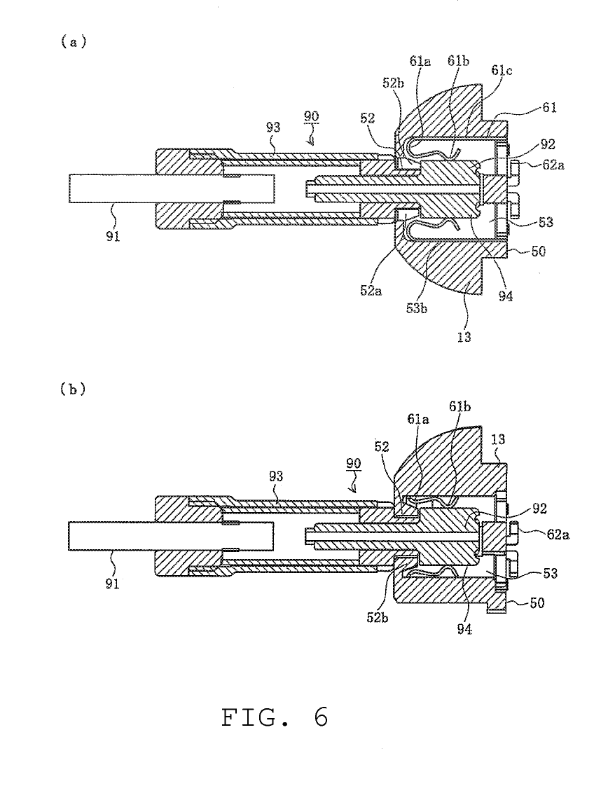

As shown in FIG. 6(a), the terminals of the receptacle 50, or namely a pair of terminal members 61 that function as receptacle terminals, are disposed within the fitting indentation 53. These terminal members 61 are disposed respectively on the pair of second sidewalls 53b that face the fitting indentation 53, and are sheet members made of metal having substantially a J-shape when viewed from above, and are given flexibility. Specifically, the terminal members 61 each comprise a main-body portion 61c extending linearly along the second sidewalls 53b of the fitting indentation 53, a contact spring portion 61a that is connected to the front end of this contact spring portion 61a so as to bend approximately 180° and whose front end extends toward the rear end of the main-body portion 61c, and a contact protrusion portion 61b formed toward the front end of this contact spring portion 61a. The contact spring portion 61a is given flexibility and functions as a spring member. In addition, the contact protrusion portions 61b protrude toward the center of the fitting indentation 53 and face each other.

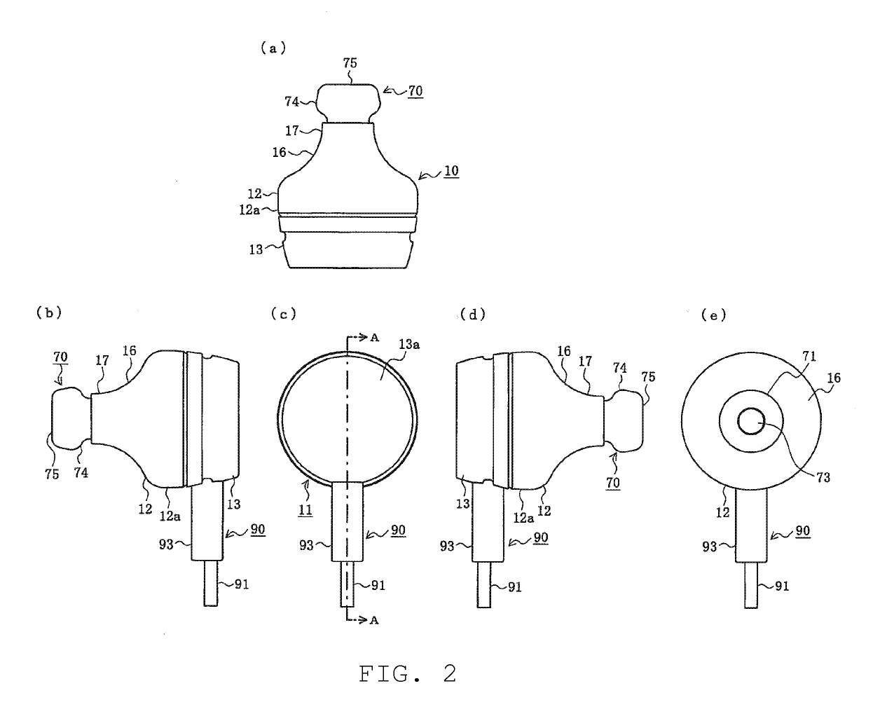

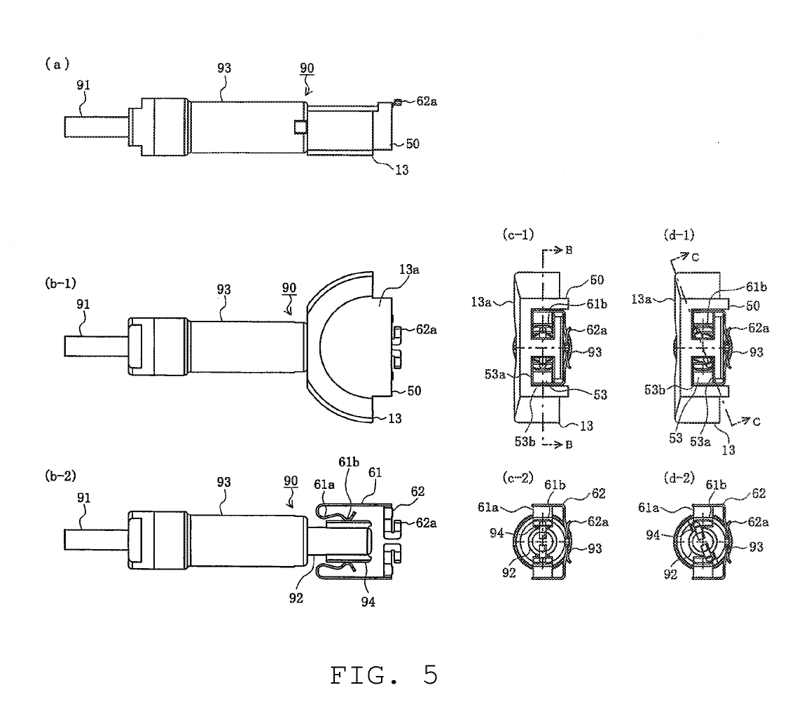

Moreover, as shown in FIGS. 5(b-2), (c-2) and (d-2), a connection tail portion 62 comprising a long, thin sheet member made of metal is connected in an integrated manner to the rear end of the main-body portion 61c of the terminal members 61. This connection tail portion 62 comprises a connection end portion 62a formed on its rear end and that protrudes rearward from the rear end of the receptacle 50. This connection end portion 62a is a portion that is connected by soldering or other connection means to the driver unit 41 so as be electrically continuous, being positioned toward the upper surface of the receptacle 50.

Moreover, when the plug 90 is to be fitted into the receptacle 50, the user of the earphone 10 first, as shown in FIGS. 3(b)-(c) and 4, faces the front end surface of the plug 90 toward the fitting surface 50a of the receptacle 50 and aligns the plug 90 such that its centerline is coaxial with the centerline of the insertion opening 52, and moreover adjusts the attitude of the plug 90 so that the engaging protrusions 94 face the engaging indentations 52a. In this state, the plug 90 and/or receptacle 50 is moved in the direction so as to approach the other and the inserted portion 92 is inserted into the insertion opening 52. Upon doing so, the inserted portion 92 passes through the cylindrical portion 52c and enters into the interior of the fitting indentation 53. In addition, the engaging protrusions 94 also pass through the engaging indentations 52a and enter into the interior of the fitting indentation 53. Moreover, when the insertion of the inserted portion 92 into the insertion opening 52 is complete, or namely when the plug 90 is plugged into the receptacle 50, the state becomes that illustrated in FIGS. 3(a), 5(a), 5(b-1), 5(b-2), 5(c-1), 5(c-2) and 6(a).

In this case, as shown in FIG. 6(a), the rear ends (the right ends in the Figure) of the engaging protrusions 94 pass through the engaging indentations 52a and are positioned toward the rear end of the receptacle 50 past the rear ends (the left ends in the Figure) of the insertion opening wall members 52b. To wit, the entire engaging protrusions 94 pass through the engaging indentations 52a and are positioned within the fitting indentation 53. In addition, as shown in FIGS. 5(b-2) and 6(a), the engaging protrusions 94 come in contact with the contact protrusion portions 61b of the terminal members 61, thus flexibly deforming the contact spring portion 61a.

This contact spring portion 61a is set such that the distance between the facing contact protrusion portions 61b in the state with no load applied, or namely in the free state as the initial state, becomes shorter than the distance between the ridges of the opposing engaging protrusions 94. Thus, when the plug 90 is plugged into the receptacle 50 and the engaging protrusions 94 enter in between the opposing contact protrusion portion 61b within the fitting indentation 53, the gap between the contact protrusion portion 61b is widened by the engaging protrusions 94 and the contact spring portion 61a is flexibly deformed as shown in FIGS. 5(b-2) and 6(a). In this case, the contact spring portion 61a attempts to restore itself to its original shape due to its springiness, and thus the engaging protrusions 94 is sandwiched between the contact protrusion portions 61b. To wit, the contact protrusion portions 61b are pressed against the ridges of the engaging protrusions 94 by the spring force induced by the contact spring portion 61a.

Next, the user of the earphone 10 rotates the plug 90 with respect to the receptacle 50. The direction of rotation may be either direction, but in the illustrated example, as shown in FIGS. 5(d-1) and (d-2), the direction is counterclockwise when viewed from the rear of the receptacle 50. When this is done, there is a shift in position between the engaging protrusions 94 and the engaging indentations 52a, so as shown in FIG. 6(b), the rear ends (the left ends in the Figure) of the engaging protrusions 94 then face the rear ends (the right ends in the Figure) of the insertion opening wall members 52b. To wit, the engaging protrusions 94 function as locking claws and their rear ends engage the insertion opening wall members 52b, and thus the plug 90 is locked and prevented from coming out of the receptacle 50.

In addition, when the plug 90 is rotated, the axis connecting the centers of the pair of engaging protrusions 94 becomes inclined with respect to the axis connecting the centers of the facing contact protrusion portions 61b. Here, the force with which the contact protrusion portions 61b press the ridges of the engaging protrusions 94 due to the spring force generated by the contact spring portion 61a acts in parallel to the axis connecting the centers of the contact protrusion portion 61b, so if the axis connecting the centers of the pair of engaging protrusions 94 is inclined due to the plug 90 rotating in the counterclockwise direction, a moment that tends to rotate the plug 90 further in the counterclockwise direction is generated and acts on the engaging protrusions 94. In other words, the engaging protrusions 94 are pushed out from the side surfaces of this inserted portion 92 in the radial direction of the inserted portion 92, and the contact spring portion 61a comes in contact with the tips of the engaging protrusions 94 and is thus deformed, thereby generating spring force in the direction toward the central axis of the inserted portion 92, and thus the inserted portion 92 is rotated and if the direction in which the engaging protrusions 94 is pushed out is inclined toward the direction of the spring force, a moment that further rotates the inserted portion 92 acts on the engaging protrusions 94. For this reason, the plug 90 rotates further in the counterclockwise direction.

However, once the plug 90 has rotated a certain amount, as shown in FIG. 5(d-1), the front ends of the engaging protrusions 94 each come in contact with the first sidewalls 53a of the fitting indentation 53, so the rotation of the plug 90 is halted. To wit, the first sidewalls 53a function as stoppers that stop the rotation of the plug 90 at a stipulated angle of rotation. Note that this stipulated angle of rotation may be approximately 20°, for example, but it may also be set to any angle.

In addition, as shown in FIG. 5(d-1), in the state in which the plug 90 is rotated, there is less distance between the ridges of the engaging protrusions 94 pertaining to the direction parallel to the axis connecting the centers of the contact protrusion portion 61b. However, the contact spring portion 61a is set in advance so as to have the contact protrusion portion 61b press on the ridges of the engaging protrusions 94 even in this state. To wit, as shown in FIG. 5(d-1), in the state in which the plug 90 is rotated by the stipulated angle of rotation, although the contact spring portion 61a is somewhat restored it is not completely restored and still is able to generate spring force, and for this reason, the ridges of the engaging protrusions 94 are pressed by the contact protrusion portion 61b. Accordingly, the plug 90 still receives the moment from the contact protrusion portion 61b tending to rotate it in the counterclockwise direction.

Thereby, even in the case in which the earphone 10 or electrical cable 91 is subjected to vibration or some other external force, the plug 90 will not rotate in the opposite direction, so the state in which the rear ends of the engaging protrusions 94 are engaged by the insertion opening wall members 52b is maintained, thus reliably preventing the plug 90 from coming out of the receptacle 50. Also, note that in the case in which the user of the earphone 10 manually uses their fingers to rotate the plug 90 the force generated by the fingers of the user is sufficiently greater than the spring force of the contact spring portion 61a, so it is possible to rotate the plug 90 in the opposite direction against the aforementioned moment. Accordingly, this is no hindrance to the user of the earphone 10 unplugging the plug 90 from the receptacle 50.

In addition, this embodiment is described in the case in which the direction that the plug 90 rotates is counterclockwise when viewed from the rear of the receptacle 50, but this may also be the clockwise direction. Moreover, this embodiment is described in the case in which the receptacle 50 is disposed upon the case 11 of the earphone 10 and the plug 90 is connected to the end of the electrical cable 91, but the plug 90 may be disposed upon the case 11 of the earphone 10 and the receptacle 50 may be connected to the end of the electrical cable 91. To wit, it is sufficient for one of either the receptacle 50 or the plug 90 to be disposed upon the earphone 10 and the other to be connected to the electrical cable 91. Moreover, one of either the receptacle 50 or the plug 90 may be connected to the other end of the electrical cable 91 with one end connected to the earphone 10, and the other may be connected to the other end of the electrical cable 91 with one end connected to audio equipment.

Moreover, this embodiment is described in the case in which there is a pair of engaging protrusions 94, or namely two of them, but the number of engaging protrusions 94 may be three or even four or more. In this case the engaging protrusions 94 may be provided at positions found by equally dividing the circumference around the central axis of the inserted portion 92 into three parts or four or more parts. To wit, it is sufficient to dispose the engaging protrusions 94 at positions found by dividing the side surface of the inserted portion 92, which is a cylindrical surface, into three, four or more equal parts. In addition, the engaging indentations 52a and terminal members 61 should also be disposed at positions corresponding to the respective engaging protrusions 94. Thereby, the earphone connector can be made a multi-pole connector with three poles, four poles or even more poles.

In this manner, the earphone connector according to this embodiment has a plug 90 provided with a cylindrical inserted portion 92 and engaging protrusions 94 that protrude from the side surface of the inserted portion 92, and a receptacle 50 provided with fitting indentations 53 that enclose at least the front-end portion of the inserted portion 92 and an insertion opening 52 formed in a fitting surface 50a that communicates with the fitting indentation 53. Moreover, the insertion opening 52 includes a cylindrical portion 52c through which the inserted portion 92 passes and engaging indentations 52a indentation through which the engaging protrusions 94 pass, and a contact spring portion 61a that is in contact with the engaging protrusions 94 is disposed within the fitting indentation 53, so that when the inserted portion 92 is inserted into the insertion opening 52, the engaging protrusions 94 pass through the indentation and are enclosed within the interior of the fitting indentation 53 and the inserted portion 92 is rotated, the spring force of the contact spring portion 61a causes a moment that further rotates the inserted portion 92 to act on the engaging protrusions 94. This prevents the rotation of the inserted portion 92 in the opposite direction so that while the electrical cable 91 is still removable, the plug 90 will not come out of the receptacle 50, thereby preventing unwanted disconnection of the electrical cable 91 and thus a highly reliable earphone connector can be provided.

In addition, the engaging protrusions 94 protrude from the side surface of the inserted portion 92 in a direction radial to the inserted portion 92, and the contact spring portion 61a being deformed upon being put in contact with the tip of the engaging protrusions 94 generates a spring force in the direction toward the central axis of the inserted portion 92, and when the inserted portion 92 is rotated and the direction in which the engaging protrusions 94 protrudes is inclined with respect to the direction of the spring force, the moment acts upon the engaging protrusions 94. Thereby, the inserted portion 92 is rotated further in the direction of rotation. In addition, if the inserted portion 92 attempts to rotate in the opposite direction, the contact spring portion 61a becomes even more greatly deformed, so an even greater moment acts, so rotation of the inserted portion 92 in the opposite direction is effectively prevented. For this reason, even if vibration or another outside force acts upon the plug 90 or receptacle 50, the inserted portion 92 will not rotate in the opposite direction, so there will be no unwanted disconnection of the inserted portion 92 from the insertion opening 52.

Moreover, the insertion opening 52 includes insertion opening wall members 52b formed adjacent to the engaging indentations 52a, and when the inserted portion 92 is inserted into the insertion opening 52, the engaging protrusions 94 pass through the engaging indentations 52a and are enclosed within the fitting indentation 53 and then the inserted portion 92 is rotated, the insertion opening 52 engages the engaging protrusions 94, thereby preventing the inserted portion 92 from coming out from the insertion opening 52. This reliably prevents the inserted portion 92 from coming out of the insertion opening 52 when not wanted, so the reliability of the earphone connector can be increased.

Moreover, the fitting indentation 53 includes first sidewalls 53a that stop the rotation of the inserted portion 92 at a stipulated angle of rotation. Thereby, rotation of the inserted portion 92 in one direction is stopped and also the engaging protrusions 94 comes into contact with the contact spring portion 61a and it is possible to maintain the angle of rotation of the inserted portion 92 within the angles of rotation at which the moment can be received, so the rotation of the inserted portion 92 in the opposite direction is also prevented. To wit, the inserted portion 92 will not rotate in either direction, so the state of connection between the plug 90 and receptacle 50 is stable.

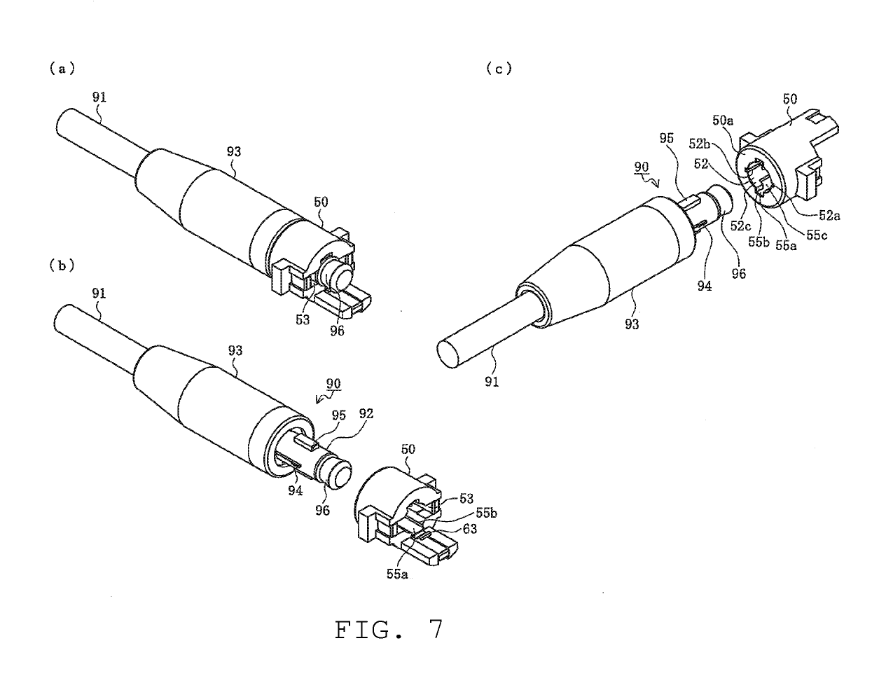

FIGS. 7-9 illustrate a further embodiment of the Present Disclosure. Note that those elements having the same structure as those in previous embodiments will be given the same symbols and their explanation will be omitted. In addition, explanation of the same operations and the same effects as in previous embodiments above will also be similarly omitted.

Note that the receptacle 50 illustrated in FIGS. 7-9 is of a different shape than the receptacle 50 illustrated in FIGS. 3-6. However, even in the case in which the receptacle 50 is a member formed integrally with the rear case 13 of the earphone 10 as described above, the example illustrated in FIGS. 7-9, like the example illustrated in FIGS. 3-6 has other portions omitted when necessary for ease of explanation, so the differences between the example illustrated in FIGS. 7-9 and the example illustrated in FIGS. 3-6 are nothing more than simply differences in the method of their omission from the drawings and they are substantially the same thing.

On the side surface of the inserted portion 92 of the plug 90 in this embodiment are disposed, in addition to a pair of engaging protrusions 94, a pair of locking protrusions 95. These locking protrusions 95 are members that function as auxiliary locking claws, being members that prevent the inserted portion 92 from coming out from the insertion opening 52. For this reason, although the engaging protrusions 94 in this embodiment need not function as members that prevent the inserted portion 92 from coming out from the insertion opening 52, they may, in the same manner as in the previous embodiment, function not only as plug terminals but also as members that prevent the inserted portion 92 from coming out from the insertion opening 52.

Moreover, the pair of engaging protrusions 94 are disposed at 180° symmetry with respect to the centerline of the inserted portion 92, and the pair of locking protrusions 95 are also disposed at 180° symmetry with respect to the centerline of the inserted portion 92. Note that the engaging protrusions 94 and the locking protrusions 95 are disposed at positions offset from each other by 90° each when viewed from the front of the plug 90. In addition, the plug 90 in this embodiment is provided with a front-end protrusion 96 which is a member that extends further forward from the front end of the inserted portion 92, and that has a shape like a upside-down truncated cone. This front-end protrusion 96 or at least the surface of its ridge is made of metal or other electrically conductive material and is connected to an electrically conductive conductor (not shown) contained within the electrical cable 91, thus functioning as a plug terminal. To wit, the plug 90 in this embodiment is a three-pole male connector provided with three plug terminals.

In this embodiment, the insertion opening 52 includes a cylindrical portion 52c that has a circular cross section, and in addition to a pair of engaging indentations 52a as indentations that are indented below the side surface of this cylindrical portion 52c, an additional pair of locking indentations locking indentations 55a as auxiliary indentations that are indented below the side surface of the cylindrical portion 52c. These locking indentations 55a are the portions into which the locking protrusions 95 of plug 90 enter and are disposed at 180° symmetry about the centerline of the cylindrical portion 52c. Note that the engaging indentations 52a and the locking indentations 55a are disposed at positions offset from each other by 90° each when viewed from the front of the receptacle 50. In addition, the above and below adjacent portions of the locking indentations 55a are insertion opening wall members 55b that extend in the forward and backward directions of the receptacle 50, engaging the rear end of the locking protrusions 95 and functioning as auxiliary detents that prevent the plug 90 from coming out.

Note that the locking indentations 55a communicate within the fitting indentation 53 with a wide indentation 55c that has a large width. Moreover, a sidewall 55d of this wide indentation 55c comes in contact with the locking protrusions 95 and thus functions as a stopper that stops the rotation of the plug 90 at a stipulated angle of rotation. Note that the stipulated angle of rotation is the same as in previous embodiments.

Moreover, a rear terminal 63 as a terminal member that contacts the front-end protrusion 96 of the plug 90 protruding from the rear end of the fitting indentation 53 is disposed upon the rear end of the receptacle 50. This rear terminal 63 is made of metal or other conducting material and functions as the receptacle terminal. To wit, the receptacle 50 in this embodiment is a three-pole female connector provided with three receptacle terminals.

Note that the constitution of other elements is identical to those of previous embodiments above, so an explanation thereof is omitted.

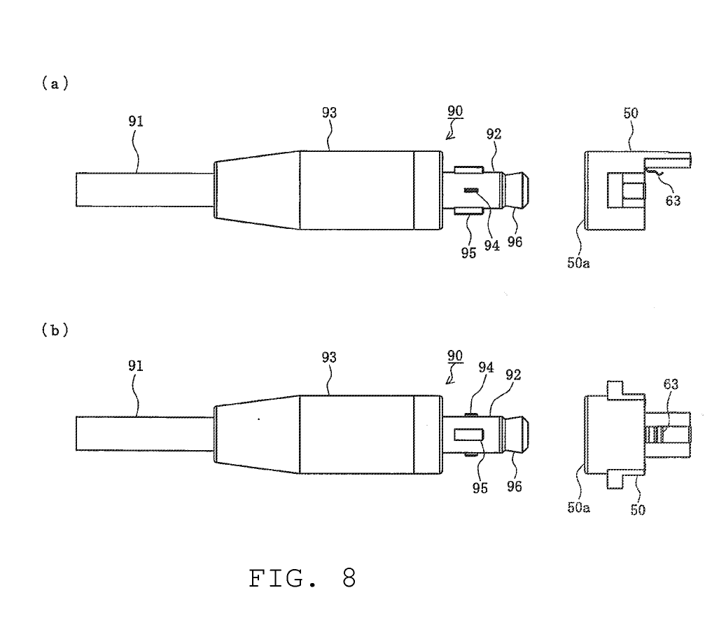

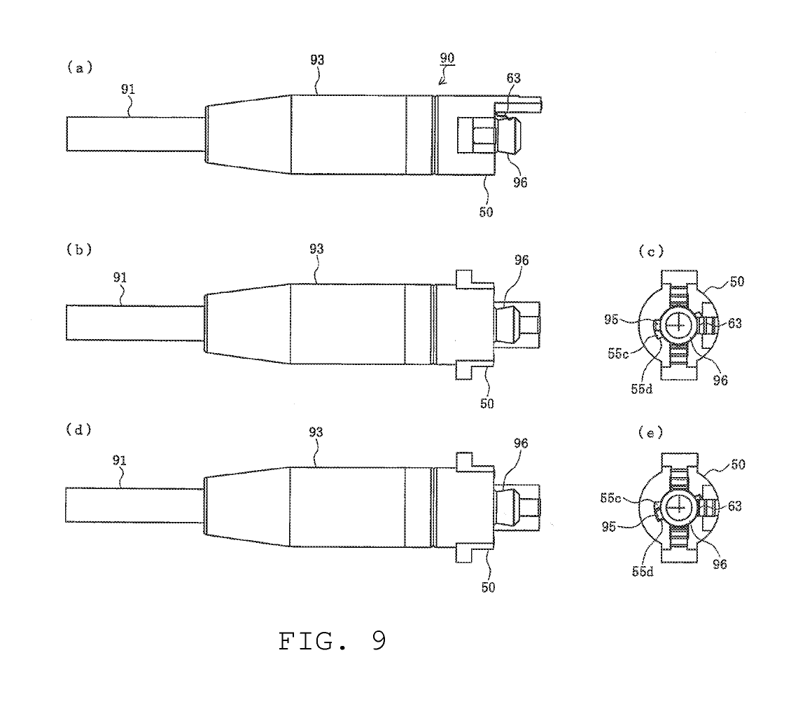

In this embodiment, when the plug 90 is to be fitted into the receptacle 50, the user of the earphone 10 first, as shown in FIGS. 7(b), 7(c) and 8, faces the front end surface of the plug 90 toward the fitting surface 50a of the receptacle 50 and aligns the plug 90 such that its centerline is coaxial with the centerline of the insertion opening 52, and moreover adjusts the attitude of the plug 90 so that the engaging protrusions 94 face the engaging indentations 52a and also the locking protrusions 95 face the locking indentations 55a. In this state, the plug 90 and/or receptacle 50 is moved in the direction so as to approach the other and the inserted portion 92 is inserted into the insertion opening 52. Upon doing so, the inserted portion 92 passes through the cylindrical portion 52c and enters into the interior of the fitting indentation 53. In addition, the engaging protrusions 94 and locking protrusions 95 also pass through the engaging indentations 52a and locking indentations 55a and enter into the interior of the fitting indentation 53. Moreover, when the insertion of the inserted portion 92 into the insertion opening 52 is complete, or namely when the plug 90 is plugged into the receptacle 50, the state becomes that illustrated in FIGS. 7(a), 9(a), 9(b) and 9(c).

In this case, the rear ends of the engaging protrusions 94 and locking protrusions 95 pass through the engaging indentations 52a and locking indentations 55a and are positioned toward the rear end of the receptacle 50 past the rear ends of the insertion opening wall members 52b and 55b. To wit, the entire engaging protrusions 94 and locking protrusions 95 pass through the engaging indentations 52a and locking indentations 55a and are positioned within the fitting indentation 53. In addition, the engaging protrusions 94 come in contact with the contact protrusion portions 61b of the terminal members 61, thus flexibly deforming the contact spring portion 61a. Moreover, the front-end protrusion 96 contacts the rear terminal 63.

Next, the user of the earphone 10 rotates the plug 90 with respect to the receptacle 50. In the illustrated example, as shown in FIG. 9(e), the direction is counterclockwise when viewed from the rear of the receptacle 50. When this is done, there is a shift in position between the engaging protrusions 94 and locking protrusions 95 and the engaging indentations 52a and locking indentations 55a, so the rear ends of the engaging protrusions 94 and locking protrusions 95 then face the rear ends of the insertion opening wall members 52b and 55b. To wit, the engaging protrusions 94 and locking protrusions 95 function as locking claws and their rear ends engage the insertion opening wall members 52b and 55b, and thus the plug 90 is locked and prevented from coming out of the receptacle 50.

In addition, when the plug 90 is rotated, in the same manner as in Embodiment 1 above, the spring force generated by the contact spring portion 61a generates a moment that tends to rotate the plug 90 further in the counterclockwise direction. For this reason, the plug 90 rotates further in the counterclockwise direction. However, once the plug 90 has rotated a certain amount, as shown in FIG. 9(e), the locking protrusions 95 each come in contact with the sidewalls 55d of the wide indentation 55c, so the rotation of the plug 90 is halted. In addition, in the same manner as in previous embodiments above, in the state in which the plug 90 is rotated by the stipulated angle of rotation, the plug 90 still receives the moment from the contact protrusion portion 61b of the contact spring portion 61a tending to rotate it in the counterclockwise direction. Thereby, even in the case in which the earphone 10 or electrical cable 91 is subjected to vibration or some other external force, the plug 90 will not rotate in the opposite direction, so the state in which the rear ends of the engaging protrusions 94 and locking protrusions 95 are engaged by the insertion opening wall members 52b and 55b is maintained, thus reliably preventing the plug 90 from coming out of the receptacle 50.

In this manner, in this embodiment, furthermore the plug 90 is further provided with locking protrusions 95 that protrude from the side surface of the inserted portion 92, and the insertion opening 52 is further provided with locking indentations 55a through which the locking protrusions 95 pass and insertion opening wall members 55b formed adjacent to the locking indentations 55a, so that when the inserted portion 92 is inserted into the insertion opening 52, the locking protrusions 95 pass through the engaging indentations 52a and are enclosed within the fitting indentation 53 and then the inserted portion 92 is rotated, the insertion opening wall members 55b engage the locking protrusions 95, thus preventing the inserted portion 92 from coming out of the insertion opening 52. This reliably prevents the inserted portion 92 from coming out of the insertion opening 52 when not wanted, so the reliability of the earphone connector can be increased.

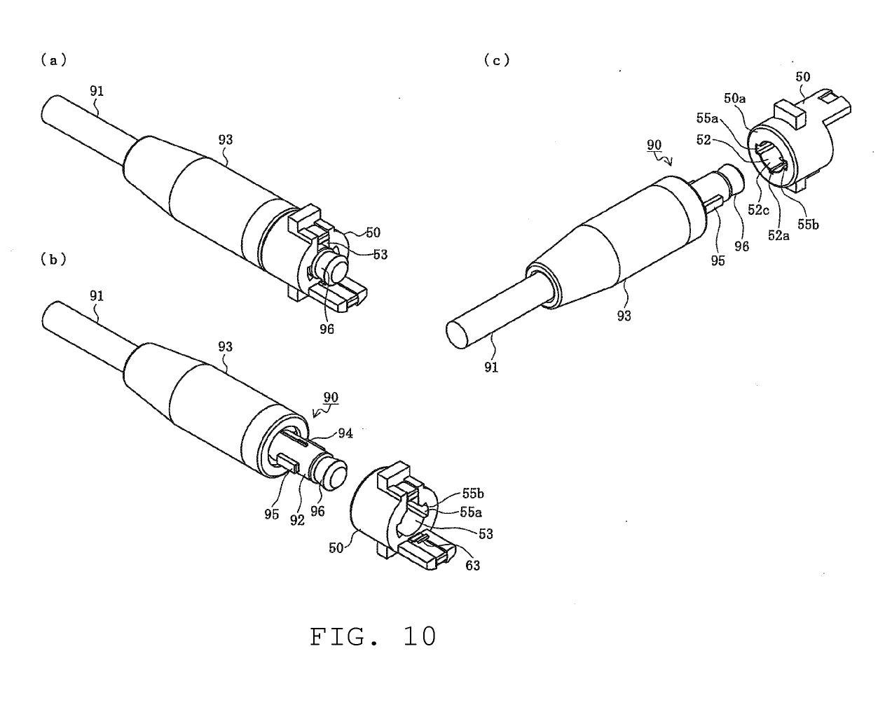

FIG. 10-2 illustrate a further embodiment of the Present Disclosure. Note that those elements having the same structure as those in previous embodiments will be given the same symbols and their explanation will be omitted. In addition, explanation of the same operations and the same effects as in previous embodiments will also be similarly omitted.

In this embodiment, there is only one engaging protrusion 94 that is disposed on the side surface of the inserted portion 92 of the plug 90. To wit, in this embodiment, the engaging protrusion 94 is singular and not a plurality as in previous embodiments. For this reason, there is only a single and not a plurality of engaging indentations 52a in the receptacle 50. Moreover, there is also only a single and not a plurality of the terminal members 61 that contact the engaging protrusion 94 and function as receptacle terminals, and there is also only a single and not a plurality of connection tail portions 62 that are connected to the terminal member 61.

Note that the constitution of other elements is identical to those of previous embodiments, so an explanation thereof is omitted. In addition, the operation at the time that the plug 90 is fitted into the receptacle 50 is als the same as that of previous embodiments, with the exception that there is only a single and not a plurality of the engaging protrusions 94, engaging indentations 52a, terminal members 61 and the like, so an explanation thereof is omitted.

While a preferred embodiment of the Present Disclosure is shown and described, it is envisioned that those skilled in the art may devise various modifications without departing from the spirit and scope of the foregoing Description and the appended Claims.

What is claimed is:

1. An earphone connector, comprising:
a cable electrically connected to a driver unit that generates sound and is provided with an earphone;
wherein the earphone connector comprises:
a plug provided with a cylindrical inserted portion and a locking claw that protrudes from the side surface of the inserted portion; and
a receptacle provided with a fitting indentation that encloses at least the front-end portion of the inserted portion and an insertion opening formed in a fitting surface that communicates with the fitting indentation, where the insertion opening includes a cylindrical portion through which the inserted portion passes and an indentation through which the locking claw passes, and a spring member that is in contact with the locking claw is disposed within the fitting indentation, so that when the inserted portion is inserted into the insertion opening, the locking claw passes through the indentation and is enclosed within the interior of the fitting indentation and the inserted portion is rotated, the spring force of the spring member causes a moment that further rotates the inserted portion to act on the locking claw.

2. The earphone connector according to claim 1, wherein the locking claw protrudes from the inserted portion in a direction radial to the inserted portion.

3. The earphone connector according to claim 2, wherein the spring member being deformed upon being put in contact with the tip of the locking claw generates a spring force in the direction toward the central axis of the inserted portion.

4. The earphone connector according to claim 3, wherein when the inserted portion is rotated and the direction in which the locking claw protrudes is inclined with respect to the direction of the spring force, the moment acts upon the locking claw.

5. The earphone connector according to claim 4, wherein the insertion opening includes a detent portion formed adjacent to the indentation.

6. The earphone connector according to claim 5, wherein when the inserted portion is inserted into the insertion opening, the locking claw passes through the indentation and is enclosed within the fitting indentation and then the inserted portion is rotated, the detent portion engages the locking claw, thereby preventing the inserted portion from coming out from the insertion opening.

7. The earphone connector according to claim 6, wherein: the fitting indentation includes a stopper that stops the rotation of the inserted portion at a stipulated angle of rotation.

8. The earphone connector according to claim 7, wherein: the locking claw may be a single claw or a plurality thereof.

9. The earphone connector according to claim 8, wherein the locking claw is a plug terminal and the spring member is a receptacle terminal, and thus electrical continuity is achieved through the contact of the locking claw and spring member.

10. The earphone connector according to claim 9, wherein the plug is further provided with an auxiliary locking claw that protrudes from the side surface of the inserted portion.

11. The earphone connector of claim 10, wherein the insertion opening is further provided with an auxiliary indentation through which the auxiliary locking claw passes and an auxiliary detent portion formed adjacent to the auxiliary indentation, so that when the inserted portion is inserted into the insertion opening, the auxiliary locking claw passes through the auxiliary indentation and is enclosed within the fitting indentation and then the inserted portion is rotated, the auxiliary detent portion engages the auxiliary locking claw, thus preventing the inserted portion from coming out of the insertion opening.
